(19) United States
(12) Patent Application Publication
(10) Pub. No.: US 2003/0013789 A1
(43) Pub. Date: Jan. 16, 2003

(54) Process for producing oligo (meth) acrylate-containing resin composition, catalyst for use therein and oligo (meth acrylate-containing resin composition obtained thereby

(75) Inventors: Eiichiro Takiyama, Kamakura-shi (JP); Susumu Yoshimura, Sagamihara-shi (JP); Shinichi Otsuka, Tsukui-gun (JP)

Correspondence Address: SUGHRUE MION, PLLC, 2100 Pennsylvania Avenue, NW, Washington, DC, 20037-3213, US

(73) Assignee: DJK LABORATORIES INC.

(21) Appl. No.: 10/175,509

(22) Filed: Jun. 20, 2002

(30) Foreign Application Priority Data
Jun. 20, 2001 (JP) 2001-186514

(51) Int. Cl. C08K 5/10; C08K 5/09; C08J 3/00; C08L 1/00; C08F 4/04

(52) U.S. Cl. 524/300; 524/317; 526/218.1

(57) ABSTRACT

A process for production of an oligo(meth)acrylate-containing resin, whereby a composition containing (meth)acrylic acid, an alkylene monoepoxide and a polybasic acid anhydride, a composition prepared by adding a polybasic acid anhydride to a composition containing an unsaturated monoalcohol obtained by reaction of (meth)acrylic acid and an alkylene monoepoxide, or a composition containing an unsaturated oligomer with an unsaturated group and a hydroxyl group, obtained by reaction of (meth)acrylic acid, an alkylene monoepoxide and a polybasic acid anhydride, is reacted at a temperature from 140° C. to 210° C. using a catalyst containing an organic and/or inorganic antimony compound.

### BACKGROUND OF THE INVENTION

1. Field of the Invention

The present invention relates to a process for production of an oligo(meth)acrylate-containing resin composition, to a catalyst for use therein and to an oligo(meth)acrylate-containing resin composition obtained by the process. Particularly, the invention relates to a convenient process for production of an oligo(meth)acrylate-containing resin composition such as a polyester (meth)acrylate, which is useful for a variety of purposes, to an esterification catalyst which can be used for the process, and to an oligo(meth)acrylate-containing resin composition obtained by the process.

2. Description of the Related Art

From the viewpoint of improving working environments, the present inventors have conducted much research toward improving conditions during molding of fiberglass reinforced plastic (hereinafter referred to as “FRP”), wherein, in the steps of impregnating fiberglass with polyester resin and curing the resin, workers are exposed to styrene present in the resin. However, despite numerous and varied efforts for over 20 years, a solution to this problem has not yet been found.

The main reason for this situation is that the current polyester resins are resins which contain α,β-unsaturated polybasic acids (or their acid anhydrides) as major components, together with a selected polybasic acid (or its acid anhydride), and the unsaturated polyester obtained by esterification using a selected polyhydric alcohol is dissolved in a styrene monomer. The unsaturated polyester which is the major component will generally have a molecular weight (Mn) of about 1500-3000, and is therefore a very highly viscous fluid or essentially a solid at ordinary temperature, such that it is extremely difficult to reduce the styrene content of the polyester resin to below 30 wt %, if workability during molding is considered as a factor. Consequently, no success has been achieved in providing polyester resins which either contain no volatile styrene or have its content reduced to a level which does not pose a problem in terms of workability.

It has been attempted to add styrene volatilization inhibitors such as wax to polyester resins in order to prevent volatilization of styrene. However, it is known that when the styrene content is about 20 wt % in order to ensure workability, the vaporization cannot be controlled to a practically negligible level.

Hence, the use of styrene is indispensable if a conventional unsaturated polyester is used as the main component of the polyester resin, and thus it has been difficult to achieve any fundamental improvement in the working environment.

On the other hand, oligo(meth)acrylates such as polyester (meth)acrylates, which have a polyester skeleton containing one or more acryloyl and/or methacryloyl groups (throughout the present specification, these will be collectively referred to as “(meth)acryloyl groups”) in the molecule, are generally known to have low viscosity compared to their molecular weight. If such oligo(meth)acrylates can be substituted for unsaturated polyesters in polyester resins, or even a portion thereof, it is possible that the property of low viscosity will allow reduction in the amount of styrene used for polyester resins. It may also be possible to develop polyester resins containing absolutely no styrene.

Here, “(meth)acrylates” refers to “acrylates” and/or “methacrylates”. Similarly, “(meth)acrylic acid” refers to “acrylic acid” and/or “methacrylic acid”.

The following process may be mentioned as an example of a process for production of polyester (meth)acrylates and resin compositions containing such acrylates, which is commonly employed in the prior art. The process involves, specifically,

1) first adding an acid catalyst such as sulfuric acid or para-toluenesulfonic acid to a starting material composition comprising (meth)acrylic acid, the desired polybasic acid (or its acid anhydride) and a polyhydric alcohol, subsequently adding an aromatic solvent such as benzene or toluene and heating at a temperature of about 80-100° C. or under heating while circulating the solvent, to accomplish esterification while azeotropically distilling the produced water with the solvent, and

2) then neutralizing the acid catalyst with an alkali, repeating water washing as necessary, distilling off the water and solvent, and obtaining the target polyester (meth)acrylate or resin composition containing the acrylate. This process is described in detail in “Functional Acrylic Resins”, Technosystems, 1st printing: May 25, 1985, p.439, “36.2.1 Polyester acrylates”.

One of the major reasons that such a complicated process must be employed is in order to avoid the situation that occurs when the highly polymerizable (meth)acrylic groups undergo esterification reaction and are polymerized, whereupon the polyester (meth)acrylate participates in side-reactions such as gelling, thereby impairing the applicability of the polyester (meth)acrylates.

This process, however, has a disadvantage in that, despite the relatively reasonable starting material cost for industrial production, the need for an increased number of steps results in a final resin which is slightly more expensive than ordinary resins.

Consequently, resins containing polyester (meth)acrylates have limited uses, at present being utilized only for some photocuring resins and for special adhesive purposes.

As alternatives to such a complicated process it has been attempted to apply methods using esterification catalysts such as aliphatic tertiary amines, phenol compounds with amino groups, quaternary ammonium salts and halogenated lithium compounds in place of acid catalysts such as sulfuric acid and para-toluenesulfonic acid, but because it is impossible to avoid gelling of the (meth)acryloyl groups under the reaction conditions necessary for esterification reaction, and particularly under high temperatures exceeding 140° C., these have not been investigated in terms of industrial application.

### BRIEF SUMMARY OF THE INVENTION

It is an object of the present invention to provide a convenient production process as an alternative to the conventional processes for production of oligo(meth)acrylates, such as polyester (meth)acrylates, and resin compositions containing such acrylates, which have involved complicated steps, a catalyst which can be used in the process, and an oligo(meth)acrylate-containing resin composition obtained by the process.

The present inventors have conducted much diligent research directed toward solving the problems described above. As a result, they have completed the present invention upon discovering that, by using an antimony-containing compound as the catalyst, it is possible to achieve a smooth proceeding of the esterification reaction without polymerization and gelling of (meth)acryloyl groups, even when the reaction is conducted under high temperatures of above 140° C., exceeding the limit of technical common knowledge of the prior art, in order to produce the intended oligo(meth)acrylate-containing resin compositions.

The invention was further completed upon discovering that when a composition containing (meth)acrylic acid, an alkylene monoepoxide and a polybasic acid anhydride is used as the starting material, a deglycolization reaction readily occurs in parallel with the esterification reaction.

In other words, aspect (I) of the present invention provides a process for production of an oligo(meth)acrylate-containing resin composition which comprises reacting (A) a composition containing (meth)acrylic acid, an alkylene monoepoxide and a polybasic acid anhydride, in the presence of (B) an organic and/or inorganic antimony compound, at a temperature from 140-210° C.

Aspect (II) of the invention provides a process for production of an oligo(meth)acrylate-containing resin composition which comprises reacting (A) a composition obtained by adding a polybasic acid anhydride to an unsaturated monoalcohol-containing composition obtained by reaction of (meth)acrylic acid and an alkylene monoepoxide, in the presence of (B) an organic and/or inorganic antimony compound at a temperature from 140-210° C.

Aspect (III) of the invention provides a process for production of an oligo(meth)acrylate-containing resin composition which comprises reacting (A) a composition containing an unsaturated oligomer with an unsaturated group and a hydroxyl group, obtained by reaction of (meth)acrylic acid, an alkylene monoepoxide and a polybasic acid anhydride, in the presence of (B) an organic and/or inorganic antimony compound at a temperature from 140-210° C.

Aspect (IV) of the invention provides a catalyst for production of an oligo(meth)acrylate-containing resin composition, which comprises an antimony-containing compound and which can be used for a process for production of an oligo(meth)acrylate-containing resin composition according to any one of aspects (I) to (III) described above.

Aspect (V) of the invention provides an oligo(meth)acrylate-containing resin composition produced by a process for production of an oligo(meth)acrylate-containing resin composition according to any one of aspects (I) to (III) described above.

More specifically, the present invention provides the following, for example.

[1] A process for production of an oligo(meth)acrylate-containing resin composition which comprises reacting (A) a composition containing (meth)acrylic acid, an alkylene monoepoxide and a polybasic acid anhydride, in the presence of (B) an organic and/or inorganic antimony compound, at a temperature from 140-210° C.

[2] A process for production of an oligo(meth)acrylate-containing resin composition which comprises reacting (A) a composition obtained by adding a polybasic acid anhydride to an unsaturated monoalcohol-containing composition obtained by reaction of (meth)acrylic acid and an alkylene monoepoxide, in the presence of (B) an organic and/or inorganic antimony compound, at a temperature from 140-210° C.

[3] A process for production of an oligo(meth)acrylate-containing resin composition which comprises reacting (A) a composition containing an unsaturated oligomer with an unsaturated group and a hydroxyl group, obtained by reaction of (meth)acrylic acid, an alkylene monoepoxide and a polybasic acid anhydride, in the presence of (B) an organic and/or inorganic antimony compound, at a temperature from 140-210° C.

[4] A process according to any one of [1] to [3] above, wherein the reaction is carried out in the presence of oxygen.

[5] A process for production of an oligo(meth)acrylate-containing resin composition, which comprises the following steps I to III.

Step I

A step of obtaining a starting material composition comprising (meth)acrylic acid, an alkylene monoepoxide and a polybasic acid anhydride.

Step II

A step of heating the starting material composition obtained in step I in a sealed system in the presence of a catalyst for reaction to obtain a reaction mixture (1).

Step III

A step of reacting the reaction mixture (1) obtained in step II in the presence of an organic and/or inorganic antimony compound at a temperature of 140-210° C. to obtain an oligo(meth)acrylate-containing resin composition.

[6] A process according to [5] above, wherein step III is carried out in the presence of oxygen.

[7] A process for production of an oligo(meth)acrylate-containing resin composition, which comprises the following steps I to IV.

Step I

A step of obtaining a starting material composition comprising (meth)acrylic acid and an alkylene monoepoxide.

Step II

A step of heating the starting material composition obtained in step I in a sealed system in the presence of a catalyst for reaction to obtain a reaction mixture (2).

Step III

A step of adding a polybasic acid anhydride to the reaction mixture (2) obtained in Step II to obtain a reaction mixture (3).

Step IV

A step of reacting the reaction mixture (3) obtained in step III in the presence of an organic and/or inorganic antimony compound at a temperature of 140-210° C. to obtain an oligo(meth)acrylate-containing resin composition.

[8] A process according to [7] above, wherein step IV is carried out in the presence of oxygen.

[9] A process according to any one of [1] to [8] above, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

[10] A process according to any one of [1] to [9] above, wherein the polybasic acid anhydride is a saturated polybasic acid anhydride and/or an unsaturated polybasic acid anhydride.

[11] A process according to [10] above, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

[12] A process according to [10] above, wherein the unsaturated polybasic acid anhydride is maleic anhydride.

[13] A process according to any one of [1] to [12] above, wherein the organic and/or inorganic antimony compound is at least one selected from the group consisting of antimony trioxide, triphenylantimony, potassium antimonyl tartrate (tartar emetic) and antimony acetate.

[14] A catalyst for production of an oligo(meth)acrylate-containing resin composition, which catalyst comprises an organic and/or inorganic antimony compound used in a process for production of an oligo(meth)acrylate-containing resin composition according to any one of [1] to [13] above.

[15] An oligo(meth)acrylate-containing resin composition which is produced by a process for production of an oligo(meth)acrylate-containing resin composition according to any one of [1] to [13] above.

### DETAILED DESCRIPTION OF THE INVENTION

The present invention will now be explained in detail with reference to its preferred modes.

Aspects (I) to (III) of the invention will be explained first.

Aspects (I) to (III) of the invention are all processes for production of an oligo(meth)acrylate-containing resin composition which comprise reacting a prescribed starting material composition in the presence of an organic and/or inorganic antimony compound at a temperature from 140-210° C.

As explained above, with conventional catalysts it has not been possible to avoid gelling by polymerization of (meth)acryloyl groups at high reaction temperatures exceeding 140° C. in the production processes, and therefore no process has existed for producing oligo(meth)acrylate-containing resin compositions under such high temperatures.

As a result of investigation into processes for production of oligo(meth)acrylate-containing resin compositions using various compounds as catalysts, the present inventors have completed the present invention after discovering, surprisingly, that when an antimony-containing compound is used as the catalyst, the esterification and deglycolization reaction occur smoothly at high temperatures of 140° C. and above, which have been unthinkable in the prior art, without gelling and even in the presence of (meth)acryloyl groups, thereby yielding the intended oligo(meth)acrylate-containing resin composition.

As a more concrete description of a preferred working mode, the process of aspect (I) of the invention comprises, for example, the following Step I and Step II.

Step I

A step of obtaining a starting material composition containing (meth)acrylic acid, an alkylene monoepoxide and a polybasic acid anhydride.

Step II

A step of reacting the starting material composition obtained in Step I in the presence of an organic and/or inorganic antimony compound at a temperature from 140-210° C. to obtain an oligo(meth)acrylate-containing resin composition.

There are no particular restrictions on the (meth)acrylic acid used for the starting material composition in Step I. It may be used without any special purification whether it is reagent grade, industrial grade or commercial grade. A high-purity product is, of course, preferred from the standpoint of minimizing side-reactions. Acrylic acid and methacrylic acid may each be used alone, or they may be used in admixture.

The alkylene monoepoxide in the starting material composition used for Step I is not particularly restricted so long as it is a compound with an epoxy ring. Specifically there may be mentioned ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate, as well as mixtures of two or more thereof. Ethylene oxide, propylene oxide and mixtures thereof are preferred from the standpoint of ready availability and practical utility of the resulting oligo(meth)acrylate-containing resin composition.

There are no particular restrictions on the alkylene monoepoxide, and any ordinary commercial product may be used. This naturally includes high-purity products, but products containing impurities or in diluted form may also be used if there is no effect on the production process of the invention. For example, in the case of ethylene oxide, the material used may contain an inert gas such as nitrogen, or a lower saturated hydrocarbon such as methane or ethane.

There are also no particular restrictions on the polybasic acid anhydride in the starting material composition for Step I. Any polybasic acid anhydride commonly used for production of saturated polyesters or production of unsaturated polyesters may be used. As specific examples there may be mentioned saturated polybasic acid anhydrides such as phthalic anhydride, tetrahydrophthalic anhydride, methyltetrahydrophthalic anhydride, endomethylene tetrahydrophthalic anhydride, HET acid and tetrabromophthalic anhydride, as well as mixtures of two or more of these. Maleic anhydride may be mentioned as an unsaturated polybasic acid anhydride. A more detailed description is found in “Polyester Resin Handbook”, first printing, Jun. 30, 1988 by Nikkan Kogyo Shimbun, pp.31-32. Maleic anhydride and/or phthalic anhydride are preferred from the viewpoint of ready availability and practical utility of the oligo(meth)acrylate-containing resin composition.

There are no particular restrictions on the proportions of the (meth)acrylic acid, alkylene monoepoxide and polybasic acid anhydride in the starting material composition for Step I. The optimum values will differ depending on the nature of the starting material and on the desired properties for the final oligo(meth)acrylate-containing resin composition.

Specifically the molar ratio is preferably in the range of, for example, (meth)acrylic acid:alkylene epoxide:polybasic anhydride =1:0.1-100:0.1-100, and more preferably in the range of (meth)acrylic acid:alkylene epoxide:polybasic anhydride =1:0.5-50:0.5-50.

In Step II, the oligo(meth)acrylate may be produced by two different reactions, an esterification reaction and/or deglycolization reaction. In this case, the two reactions may be conducted simultaneously in the same reactor, or each may be conducted successively using separate reactors.

As a concrete example, there may be mentioned a process such as illustrated by Reaction Scheme 1 below, wherein (1) first an esterification reaction is conducted using (meth)acrylic acid (acrylic acid is used here) and an alkylene monoepoxide (ethylene oxide is used here) by ring-opening addition, resulting in a reaction mixture containing an unsaturated monoalcohol (α), and then (2) this unsaturated monoalcohol (a) and a polybasic acid anhydride (phthalic anhydride is used here) participate in ring-opening addition and subsequently esterification by dehydrating condensation, to obtain an oligo(meth)acrylate-containing resin composition.

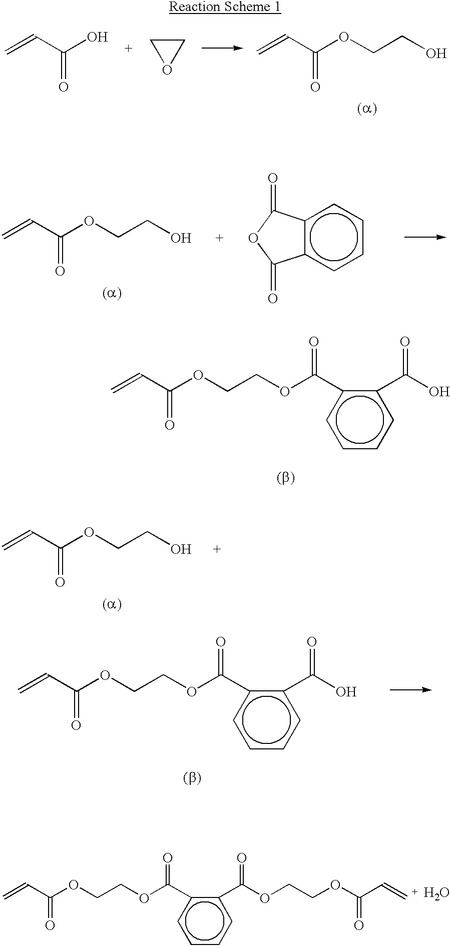

In this scheme, Step II is preferably carried out by way of the following two steps, for example. Specifically, step (1) above is conducted in a sealed system using an autoclave or the like, and then the obtained reaction mixture is reacted at a temperature of 140-210° C. for step (2) above, to obtain the oligo(meth)acrylate-containing resin composition.

By carrying out Step II in these two steps, it is possible to avoid gasification and escape of the alkylene monoepoxide before the esterification reaction, which is situation that occurs with heating in an open system when relatively low boiling point alkylene monoepoxides such as ethylene oxide or propylene oxide are used as starting materials. This method is therefore preferred to accomplish a more efficient reaction.

A preferred process for production of an oligo(meth)acrylate-containing resin composition comprises the following Steps I to III.

Step I

A step of obtaining a starting material composition comprising (meth)acrylic acid, an alkylene monoepoxide and a polybasic acid anhydride.

Step II

A step of heating the starting material composition obtained in step I in a sealed system in the presence of a catalyst for reaction to obtain a reaction mixture (1).

Step III

A step of reacting the reaction mixture (1) obtained in Step II in the presence of an organic and/or inorganic antimony compound at a temperature of 140-210° C. to obtain an oligo(meth)acrylate-containing resin composition.

In the process comprising Steps I to III described above, the catalyst for Step II may be the same as the organic and/or inorganic antimony compound used for Step III, or it may be a different one. When it is the same one, the organic and/or inorganic antimony compound may be further added for Step III, or the one used for Step II may be used again directly.

The reaction occurring in Step II of the process comprising Steps I to III described above is not limited strictly to an esterification reaction, and therefore the reaction mixture (1) may contain other products in addition to the unsaturated monoalcohol (a) shown in Reaction Scheme 1.

As a modification of the process for production of an oligo(meth)acrylate-containing resin composition comprising Steps I to III described above, there may be mentioned a process comprising Steps I to IV below.

Step I

A step of obtaining a starting material composition comprising (meth)acrylic acid and an alkylene monoepoxide.

Step II

A step of heating the starting material composition obtained in step I in a sealed system in the presence of a catalyst for reaction to obtain a reaction mixture (2).

Step III

A step of adding a polybasic acid anhydride to the reaction mixture (2) obtained in Step II to obtain a reaction mixture (3).

Step IV

A step of reacting the reaction mixture (3) obtained in step III in the presence of an organic and/or inorganic antimony compound at a temperature of 140-210° C. to obtain an oligo(meth)acrylate-containing resin composition.

In the process for production of an oligo(meth)acrylate-containing resin composition comprising Steps I to IV as well, the catalyst used in Step II may be the same as the organic and/or inorganic antimony compound used for Step IV, or it may be a different one. When it is the same one, the organic and/or inorganic antimony compound may be further added in Step IV, or the one used for Step II may be used again directly.

Another concrete example is shown below in Reaction Scheme 2, as a process wherein (1) a compound (β) with an unsaturated group and a carboxylic acid group, obtained by ring-opening reaction with an unsaturated monoalcohol (α) obtained in the same manner as Reaction Scheme 1 and a polybasic acid anhydride (phthalic anhydride is used here), participates in ring-opening addition of an alkylene monoepoxide (ethylene oxide is used here) to obtain a reaction mixture containing an unsaturated oligomer (γ) comprising an unsaturated group and a hydroxyl group, and then (2) a deglycolization reaction is conducted with the unsaturated oligomers (γ) and (α) and/or esterification reaction by dehydrating condensation is conducted with the unsaturated oligomers (γ) and (β), to obtain an oligo(meth)acrylate-containing resin composition.

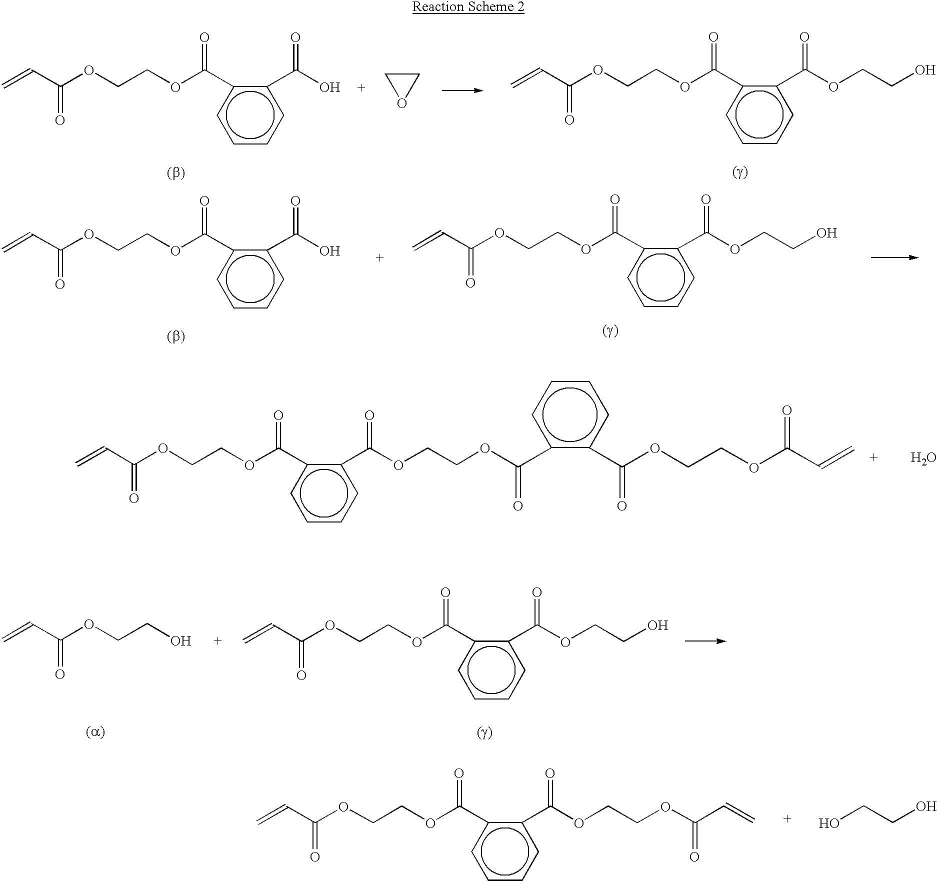

In this case as well, Step II is preferably carried out by way of the following two steps, for example. Specifically, step (1) above is conducted in a sealed system using an autoclave, and then the obtained reaction mixture is reacted at a temperature of 140-210° C. for step (2) above, to obtain the oligo(meth)acrylate-containing resin composition. These reaction schemes are, needless to mention, merely illustrations and do not limit aspect (I) of the present invention in any manner whatsoever.

There are no particular restrictions on the organic and/or inorganic antimony compound which may be used in Step II (or in Step III or Step IV of the preferred production process described above as a specific example; same hereunder). There are also no particular restrictions on the its properties so long as the compound contains antimony. As specific examples there may be mentioned antimony trioxide, triphenylantimony, potassium antimonyl tartrate (tartar emetic) and antimony acetate, as well as mixtures of two or more thereof. From the standpoint of ready availability and effect as a catalyst, antimony trioxide is preferred as an inorganic compound and triphenylantimony is preferred as an organic compound. Both of these may of course be used in combination.

There are no particular restrictions on the amount of the organic and/or inorganic antimony compound which may be used in Step II. It is preferably in the range of 0.01-1 part by weight with respect to 100 parts by weight of the starting material composition obtained in Step I. At less than 0.01 part by weight, the effect as a catalyst may be inadequate. Also, no further effect is seen with addition at greater than 1 part by weight, while curability of the resulting oligo(meth)acrylate-containing resin composition may be impaired. The amount is more preferably in the range of 0.05-0.5 part by weight.

In Step II, the organic and/or inorganic antimony compound may be used together with a compound which aids its effect. Specifically there may be mentioned, for example, compounds such as titanium alkoxides and the like. The amount thereof used may be approximately the same as the amount of the organic and/or inorganic antimony compound.

As mentioned above, an esterification reaction and/or a deglycolization reaction occurs in Step II, and the reaction temperature therefor may be in the range of 140-210° C. With conventional catalysts it has been impossible to avoid gelling by polymerization of the (meth)acryloyl groups under such conditions, but the process of the invention allows this problem to be overcome by using an organic and/or inorganic antimony compound as the catalyst. As a result, it is possible to achieve complete esterification reaction and/or deglycolization reaction within a very short time to synthesize an oligo(meth)acrylate, thereby yielding an oligo(meth)acrylate-containing resin composition.

When the reaction temperature is below 140° C., the reaction rate and particularly the rate of the deglycolization reaction is slowed, or else the reaction fails to go to completion. If the reaction temperature exceeds 210° C., it may become difficult to avoid gelling by polymerization of the (meth)acryloyl groups. The temperature range is more preferably 150-200° C., and most preferably 160-190° C.

In Step II, the reaction is preferably carried out in the presence of oxygen. Oxygen has the function of inhibiting polymerization of the (meth)acryloyl groups, and is well known as the most convenient radical polymerization inhibitor. This also applies to Step II.

Here, the oxygen may be introduced into the reaction system as pure oxygen, or more conveniently, air may be used instead. Oxygen diluted with nitrogen or the like may of course be used as an alternative. Any method may be employed so long as it ensures an oxygen concentration with a polymerization-inhibiting effect.

Incidentally, the esterification reaction accompanied by dehydrating condensation and the deglycolization reaction are equilibrium reactions, and removal of the produced water or glycol out of the system in order to shift the equilibrium towards the products is preferred for the progress of these reactions. It is common to carry out the reaction under reduced pressure in order to facilitate removal of these from the system. However, if the degree of pressure reduction is too great, the oxygen concentration in the system is reduced, resulting in a lower polymerization-inhibiting effect or possibly eliminating the effect.

In the production process according to aspect (I) of the present invention, the degree of pressure reduction is preferably not too great from the standpoint of the balance between the polymerization-inhibiting effect by oxygen and the reaction rate. Specifically, the pressure is preferably at least 500 mmHg even with pressure reduction. In this case, the reaction temperature will depend on the degree of pressure reduction but is preferably in the range of 140-180° C.

Aspect (II) of the invention will now be explained. Aspect (II) of the invention is a process for production of an oligo(meth)acrylate-containing resin composition which comprises reacting (A) a composition obtained by adding a polybasic acid anhydride to an unsaturated monoalcohol-containing composition obtained by reaction of (meth)acrylic acid, and an alkylene monoepoxide, in the presence of (B) an organic and/or inorganic antimony compound, at a temperature from 140-210° C.

The (meth)acrylic acid, alkylene monoepoxide and polybasic acid anhydride for aspect (II) are the same as for aspect (I). The antimony compound is also the same as for aspect (I), and the reaction conditions are also the same as for aspect (I).

As the unsaturated monoalcohol according to aspect (II) there may be specifically mentioned, for example, (a) in Reaction Scheme 1 for aspect (I), but this is not limitative. That is, there are no particular restrictions so long as the unsaturated monoalcohol has in each molecule an unsaturated group as a polymerizable functional group and a hydroxyl group, and is obtained by reacting (meth)acrylic acid and an alkylene monoepoxide. Alternatively, it may be an unsaturated monoalcohol obtained by reacting (meth)acrylic acid or its ester with a diol. That is, it may be an unsaturated monoalcohol produced separately by a conventional publicly-known method, and purified if necessary. Naturally, the unsaturated monoalcohol-containing reaction mixture obtained by reaction between the (meth)acrylic acid and alkylene monoepoxide under various conditions may be used directly, so long as it does not affect the production process for the final oligo(meth)acrylate-containing resin composition or its properties. The unsaturated monoalcohol-containing reaction mixture obtained by reaction between the (meth)acrylic acid and alkylene monoepoxide under various conditions will generally be a mixture of various different products, but even such a reaction mixture may be used if it contains the unsaturated monoalcohol as a portion thereof.

Aspect (III) of the invention will now be explained. Aspect (III) of the invention is a process for production of an oligo(meth)acrylate-containing resin composition which comprises reacting (A) a composition containing an unsaturated oligomer with an unsaturated group and a hydroxyl group, obtained by reaction of (meth)acrylic acid, an alkylene monoepoxide and a polybasic acid anhydride, in the presence of (B) an organic and/or inorganic antimony compound at a temperature from 140-210° C.

The (meth)acrylic acid, alkylene monoepoxide and polybasic acid anhydride for aspect (III) are the same as for aspect (I). The antimony compound is also the same as for aspect (I), and the reaction conditions are also the same as for aspect (I).

As a specific example of the unsaturated oligomer with an unsaturated group and a hydroxyl group for aspect (III) there may be mentioned (y) in Reaction Scheme 2 for aspect (I), but this is not limitative. That is, there are no particular restrictions so long as the unsaturated oligomer has, in each molecule, an unsaturated group as a polymerizable functional group and a hydroxyl group, and is obtained by reacting (meth)acrylic acid, an alkylene monoepoxide and a polybasic acid anhydride.

Thus, it may be an unsaturated oligomer produced separately by a conventional publicly known method, and purified if necessary. Naturally, the unsaturated oligomer-containing reaction mixture obtained by reaction between the (meth)acrylic acid, alkylene monoepoxide and polybasic acid anhydride under various conditions may be used directly, so long as it does not affect the production process for the final oligo(meth)acrylate-containing resin composition or its properties. The unsaturated oligomer-containing reaction mixture obtained by reaction between the (meth)acrylic acid, alkylene monoepoxide and polybasic acid anhydride under various conditions will generally be a mixture of various different products, but even such a reaction mixture may be used if it contains the unsaturated oligomer as a portion thereof.

Aspect (IV) of the invention will now be explained. Aspect (IV) of the invention is a catalyst for production of an oligo(meth)acrylate-containing resin composition, which comprises an antimony-containing compound and which can be used in a process for production of an oligo(meth)acrylate-containing resin composition according to any one of aspects (I) to (III) of the invention.

The catalyst for production of an oligo(meth)acrylate-containing resin composition according to aspect (IV) is not particularly restricted so long as one of its components is an antimony-containing compound. As specific examples there may be mentioned antimony trioxide, triphenylantimony, potassium antimonyl tartrate (tartar emetic) and antimony acetate. From the standpoint of ready availability and effect as a catalyst, antimony trioxide is preferred as an inorganic compound and triphenylantimony is preferred as an organic compound. Both of these may of course be used in combination. A commercially available product may be used without modification, but it may instead be purified if necessary.

Aspect (V) of the invention will now be explained. Aspect (V) of the invention is an oligo(meth)acrylate-containing resin composition produced by a process for production of an oligo(meth)acrylate-containing resin composition according to any one of aspects (I) to (III) of the invention.

The oligo(meth)acrylate-containing resin composition according to aspect (V) is an oligo(meth)acrylate-containing resin composition produced using a catalyst comprising an antimony-containing compound, at high temperature within a short time, and without gelling. The composition therefore differs from oligo(meth)acrylates that are produced by conventional oligo(meth)acrylate production processes, for example, by the process of removing the water product using an azeotropic solvent at relatively low temperature in the presence of an acid catalyst, as described above, and it requires no catalyst neutralization or removal, or azeotropic solvent removal. The production steps are therefore simplified, thus allowing production to be accomplished in a very inexpensive manner.

Without purification by catalyst removal, etc., the catalyst comprising the antimony-containing compound will remain in the oligo(meth)acrylate-containing resin composition, but this will not particularly affect the polymerization properties of the resin composition. Purification may be carried out by a conventional publicly known method primarily aimed at catalyst removal, and such purification will pose no problem whatsoever.

The catalyst comprising the antimony-containing compound included in the oligo(meth)acrylate-containing resin composition according to aspect (V) of the invention may be analyzed and quantified by analytical methods which are publicly known in the prior art, such as atomic absorption spectroscopy.

The oligo(meth)acrylate-containing resin composition according to aspect (V) may be used together with other materials which are conventionally known for use in resin starting material compositions. Examples of such materials include inorganic and/or organic reinforcers, fillers, release agents, defoaming agents and coloring agents.

As specific examples of inorganic and/or organic reinforcers there may be mentioned fiberglass, carbon fiber, aramid fiber, vinylon fiber, metal fiber and the like.

As specific examples of fillers there may be mentioned calcium carbonate, magnesium carbonate, barium sulfate, calcium sulfate, aluminum hydroxide, clay, talc, kaolin, diatomaceous earth, mica powder, fiberglass powder, asbestos powder, silica gel, rock wool and the like.

As specific examples of release agents there may be mentioned wax, metal salts of stearic acid, such as zinc stearate, and the like.

As specific examples of defoaming agents there may be mentioned silicone oil, polyvinyl ether, acrylic acid ester copolymers, fluorine-based compounds and the like.

The present invention will now be further explained by way of examples, which are only intended as a general explanation of the invention and are in no way limitative thereon.

### EXAMPLE 1

### Production and Evaluation of oligo(meth)acrylate (A)

(1) Production of oligo(meth)acrylate (A)

In a 1 liter separable flask equipped with a stirrer, a fractionating condenser, a thermometer and a gas introduction tube there were charged 265 g of 2-hydroxyethyl methacrylate, 148 g of phthalic anhydride, 0.05 g of phenothiazine and 1.3 g of triphenylantimony, and reaction was conducted in an air stream at 180 to 185° C. for 80 minutes. No gelling occurred during this period. The final distillate yield was 37 g, and the acid value of the reaction mixture was 44. Approximately ⅓ of the distillate was estimated to be glycol resulting from deglycolization reaction, with the remaining approximately ⅔ consisting of water separated by esterification. The obtained oligo(meth)acrylate (A) was light yellow with a viscosity of about 7 to 8 poise.

(2) Evaluation of oligo(meth)acrylate (A)

A system prepared by adding 4 parts by weight of benzoyl peroxide (50%, DOP paste) and 0.2 part by weight of dimethylaniline to 100 parts by weight of oligo(meth)acrylate (A) was gelled for 23 minutes and rapidly heat-released for curing.

A 3 m/m thick cast panel obtained by curing in this manner had a flexural strength 12.1-13.5 kg/mm², an elastic modulus coefficient of approximately 430, a Barcol hardness of 43 and a heat deformation temperature of 97° C.

### EXAMPLE 2

### Production and Evaluation of oligo(meth)acrylate (B)

(1) Synthesis of Hydroxyl Group-Containing Unsaturated Oligomer

In a 1 liter glass autoclave (20 kg/cm² pressure resistant) there were charged 172 g of methacrylic acid, 192 g of propylene oxide, 148 g of phthalic anhydride, 1.5 g of dimethylbenzylamine, 0.05 g of phenothiazine and 0.75 g of antimony trioxide, and reaction was conducted for 2 hours at 130 to 135° C. and a maximum pressure of 5 kg/cm², while controlling a rapid heat release. The acid value was 0. A reaction mixture containing a light rose-colored hydroxyl group-containing unsaturated oligomer was obtained. The yield was approximately quantitative.

(2) Production of oligo(meth)acrylate (B)

The reaction mixture obtained in (1) was transferred to a 1 liter separable flask equipped with a fractionating condenser, gas introduction tube, stirrer and thermometer, and deglycolization reaction was conducted in an air stream at 180 to 185° C. for 80 minutes while vigorously stirring. As a result, 78 g of propylene glycol was obtained as a final distillate. The oligo(meth)acrylate (B) was yellowish brown, with slight turbidity and a viscosity of 7 to 8 poise.

(3) Evaluation of oligo(meth)acrylate (B)

A system prepared by adding 1 part by weight of methyl ethyl ketone peroxide, 0.5 part by weight of cobalt naphthenate (6 wt % Co) and 0.1 part by weight of pyrrolidine acetoacetamide (product name “NAKKUSURETA PIK” by Nippon Nyukazai Co., Ltd.) to 100 parts by weight of oligo(meth)acrylate (B) was gelled for 20 minutes and very rapidly heat-released for curing. The maximum temperature reached was 139° C.

### EXAMPLE 3

### Production and Evaluation of oligo(meth)acrylate (C)

(1) Production of oligo(meth)acrylate (C)

In the autoclave used in Example 2 there were charged 172 g of methacrylic acid, 128 g of propylene oxide, 1.2 g of benzyldimethylamine, 0.05 g of phenothiazine and 0.42 g of triphenylantimony, and reaction was conducted for 2 hours at a maximum temperature of 135° C. and a pressure of 5 kg/cm². The acid value was below 3.

The reaction mixture was then transferred to a separable flask in the same manner as Example 2, 148 g of phthalic anhydride and 0.8 g of titanium tetraisopropoxide were added, and reaction was conducted for 2 hours at a temperature of 165 to 170° C. under a reduced pressure of 600 to 650 mmHg. The amount of distillate was 140 g. The obtained oligo(meth)acrylate (C) was light yellowish brown, with a viscosity of approximately 6 to 7 poise and an acid value of 48.

(2) Evaluation of oligo(meth)acrylate (C)

A system obtained by adding a curing agent in the same manner as the evaluation of oligo(meth)acrylate (B) in Example 2 was gelled for 27 minutes and then gently and continuously heat-released. The molded product obtained by curing at 100° C. for 2 hours had a Barcol hardness of 42 to 43, a flexural strength of 12 to 14 kg/cm² and an elastic modulus coefficient of 410 to 420 kg/mm².

### EXAMPLE 4

### Production and Evaluation of oligo(meth)acrylate (D)

(1) Production of oligo(meth)acrylate (D)

In the autoclave used in Example 2 there were charged 144 g of acrylic acid, 166 g of propylene oxide, 89 g of phthalic anhydride, 1.2 g of dimethylbenzylamine, 0.44 g of phenothiazine, 0.4 g of triphenylantimony and 0.4 g of antimony trioxide, and reaction was conducted for 2 hours at a maximum temperature of 131° C. and a maximum pressure of 5 kg/cm². The acid value was below 0. A somewhat reddish reaction mixture was obtained.

The reaction mixture was then transferred to a 1 liter separable flask with the same equipment as in Example 1, and reaction was conducted for 80 minutes at a temperature of 179 to 183° C. under an air stream. The obtained oligo(meth)acrylate (D) was light reddish brown, with a viscosity of approximately 4 to 5 poise.

(2) Evaluation of oligo(meth)acrylate (D)

Three parts by weight of benzyldimethyl ketal as a photoreaction initiator was dissolved in 100 parts by weight of oligo(meth)acrylate (D) to prepare a photocuring resin.

After coating a cleaned glass panel to a thickness of 0.1 mm, it was irradiated for 1 minute at a position 15 cm under an ultraviolet lamp with an output of 1 kw. The hardness of the cured film was 3 to 4 H.

### INDUSTRIAL APPLICABILITY

According to the present invention it is possible to produce oligo(meth)acrylates and resin compositions containing the acrylates by a simple process, whereas such production has only been possible through numerous steps in the prior art. The invention also allows production of oligo(meth)acrylates in a short time at high temperatures which have been unthinkable according to the common knowledge of the prior art. The invention further allows production of oligo(meth)acrylate-containing resin compositions in an inexpensive manner by a simple process, so that oligo(meth)acrylates and resin compositions containing those acrylates may be used for a wide range of purposes, whereas they have been applied only for special purposes due to their high cost in the prior art. In particular, it is possible to produce resins which either contain no reactive diluting monomers such as styrene, or else employ them in a reduced amount at a level which does not affect the working environment.

What we claim is:

1. A process for production of an oligo(meth)acrylate-containing resin composition which comprises reacting (A) a composition containing (meth)acrylic acid, an alkylene monoepoxide and a polybasic acid anhydride, in the presence of (B) an organic and/or inorganic antimony compound, at a temperature from 140-210° C.

2. A process according to claim 1, wherein the reaction is carried out in the presence of oxygen.

3. A process according to claim 1, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

4. A process according to claim 1, wherein the polybasic acid anhydride is a saturated polybasic acid anhydride and/or an unsaturated polybasic acid anhydride.

5. A process according to claim 4, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

6. A process according to claim 4, wherein the unsaturated polybasic acid anhydride is maleic anhydride.

7. A process according to claim 1, wherein the organic and/or inorganic antimony compound is at least one selected from the group consisting of antimony trioxide, triphenylantimony, potassium antimonyl tartrate (tartar emetic) and antimony acetate.

8. A process for production of an oligo(meth)acrylate-containing resin composition which comprises reacting (A) a composition obtained by adding a polybasic acid anhydride, to an unsaturated monoalcohol-containing composition obtained by reaction of (meth)acrylic acid and an alkylene monoepoxide, in the presence of (B) an organic and/or inorganic antimony compound, at a temperature from 140-210° C.

9. A process according to claim 8, wherein the reaction is carried out in the presence of oxygen.

10. A process according to claim 8, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

11. A process according to claim 8, wherein the polybasic acid anhydride is a saturated polybasic acid anhydride and/or an unsaturated polybasic acid anhydride.

12. A process according to claim 11, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

13. A process according to claim 11, wherein the unsaturated polybasic acid anhydride is maleic anhydride.

14. A process according to claim 8, wherein the organic and/or inorganic antimony compound is at least one selected from the group consisting of antimony trioxide, triphenylantimony, potassium antimonyl tartrate (tartar emetic) and antimony acetate.

15. A process for production of an oligo(meth)acrylate-containing resin composition which comprises reacting (A) a composition containing an unsaturated oligomer with an unsaturated group and a hydroxyl group, obtained by reaction of (meth)acrylic acid, an alkylene monoepoxide and a polybasic acid anhydride, in the presence of (B) an organic and/or inorganic antimony compound, at a temperature from 140-210° C.

16. A process according to claim 15, wherein the reaction is carried out in the presence of oxygen.

17. A process according to claim 15, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

18. A process according to claim 15, wherein the polybasic acid anhydride is a saturated polybasic acid anhydride and/or an unsaturated polybasic acid anhydride.

19. A process according to claim 18, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

20. A process according to claim 18, wherein the unsaturated polybasic acid anhydride is maleic anhydride.

21. A process according to claim 15, wherein the organic and/or inorganic antimony compound is at least one selected from the group consisting of antimony trioxide, triphenylantimony, potassium antimonyl tartrate (tartar emetic) and antimony acetate.

22. A process for production of an oligo(meth)acrylate-containing resin composition, which comprises the following steps I to III.
Step I
A step of obtaining a starting material composition comprising (meth)acrylic acid, an alkylene monoepoxide and a polybasic acid anhydride.
Step II
A step of heating the starting material composition obtained in step I in a sealed system in the presence of a catalyst for reaction to obtain a reaction mixture (1).
Step III
A step of reacting the reaction mixture (1) obtained in Step II in the presence of an organic and/or inorganic antimony compound at a temperature of 140-210° C. to obtain an oligo(meth)acrylate-containing resin composition.

23. A process according to claim 22, wherein step III is carried out in the presence of oxygen.

24. A process according to claim 22, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

25. A process according to claim 22, wherein the polybasic acid anhydride is a saturated polybasic acid anhydride and/or an unsaturated polybasic acid anhydride.

26. A process according to claim 25, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

27. A process according to claim 25, wherein the unsaturated polybasic acid anhydride is maleic anhydride.

28. A process according to claim 22, wherein the organic and/or inorganic antimony compound is at least one selected from the group consisting of antimony trioxide, triphenylantimony, potassium antimonyl tartrate (tartar emetic) and antimony acetate.

29. A process for production of an oligo(meth)acrylate-containing resin composition, which comprises the following steps I to IV.
Step I
A step of obtaining a starting material composition comprising (meth)acrylic acid and an alkylene monoepoxide.
Step II
A step of heating the starting material composition obtained in step I in a sealed system in the presence of a catalyst for reaction to obtain a reaction mixture (2).
Step III
A step of adding a polybasic acid anhydride to the reaction mixture (2) obtained in Step II to obtain a reaction mixture (3).
Step IV
A step of reacting the reaction mixture (3) obtained in step III in the presence of an organic and/or inorganic antimony compound at a temperature of 140-210° C. to obtain an oligo(meth)acrylate-containing resin composition.

30. A process according to claim 29, wherein step IV is carried out in the presence of oxygen.

31. A process according to claim 29, wherein the alkylene monoepoxide is at least one selected from the group consisting of ethylene oxide, propylene oxide, butylene oxide, epichlorohydrin, epibromohydrin, allyl glycidyl ether, phenyl glycidyl ether, cyclohexane oxide, styrene oxide and glycidyl (meth)acrylate.

32. A process according to claim 29, wherein the polybasic acid anhydride is a saturated polybasic acid anhydride and/or an unsaturated polybasic acid anhydride.

33. A process according to claim 32, wherein the saturated polybasic acid anhydride is at least one selected from the group consisting of phthalic anhydride, tetrahydrophthalic anhydride, methyltetrahydrophthalic anhydride, endomethylenetetrahydrophthalic anhydride, HET acid and tetrabromophthalic anhydride.

34. A process according to claim 32, wherein the unsaturated polybasic acid anhydride is maleic anhydride.

35. A process according to claim 29, wherein the organic and/or inorganic antimony compound is at least one selected from the group consisting of antimony trioxide, triphenylantimony, potassium antimonyl tartrate (tartar emetic) and antimony acetate.

36. A catalyst for production of an oligo(meth)acrylate-containing resin composition, which catalyst comprises an organic and/or inorganic antimony compound used in a process for production of an oligo(meth)acrylate-containing resin composition according to claim 1.

37. A catalyst for production of an oligo(meth)acrylate-containing resin composition, which catalyst comprises an organic and/or inorganic antimony compound used in a process for production of an oligo(meth)acrylate-containing resin composition according to claim 8.

38. A catalyst for production of an oligo(meth)acrylate-containing resin composition, which catalyst comprises an organic and/or inorganic antimony compound used in a process for production of an oligo(meth)acrylate-containing resin composition according to claim 15.

39. A catalyst for production of an oligo(meth)acrylate-containing resin composition, which catalyst comprises an organic and/or inorganic antimony compound used in a process for production of an oligo(meth)acrylate-containing resin composition according to claim 22.

40. A catalyst for production of an oligo(meth)acrylate-containing resin composition, which catalyst comprises an organic and/or inorganic antimony compound used in a process for production of an oligo(meth)acrylate-containing resin composition according to claim 29.

41. An oligo(meth)acrylate-containing resin composition which is produced by a process for production of an oligo(meth)acrylate-containing resin composition according to claim 1.

42. An oligo(meth)acrylate-containing resin composition which is produced by a process for production of an oligo(meth)acrylate-containing resin composition according to claim 8.

43. An oligo(meth)acrylate-containing resin composition which is produced by a process for production of an oligo(meth)acrylate-containing resin composition according to claim 15.

44. An oligo(meth)acrylate-containing resin composition which is produced by a process for production of an oligo(meth)acrylate-containing resin composition according to claim 22.

45. An oligo(meth)acrylate-containing resin composition which is produced by a process for production of an oligo(meth)acrylate-containing resin composition according to claim 29.
